(19) United States
(12) Patent Application Publication
(10) Pub. No.: US 2005/0078699 A1
(43) Pub. Date: Apr. 14, 2005

(54) System, method, and computer program product for utilizing proprietary communication parameters to improve channel efficiency in a DOCSIS-compliant broadband communication system

(75) Inventor: Scott A. Cummings, Suwanee, GA (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation

(21) Appl. No.: 10/682,536

(22) Filed: Oct. 10, 2003

(51) Int. Cl. H04L 12/28

(52) U.S. Cl. 370/437

(57) ABSTRACT

A system, method and computer program product that provides improved bandwidth utilization in a DOCSIS-compliant broadband communication system. The system includes a cable modem termination system (CMTS) and a cable modem that support at least one proprietary communication parameter associated with bandwidth utilization that is not defined by, or encompasses values that are not provided for by, the DOCSIS specification. The proprietary communication parameter may include a modulation rate, a base rate, or an alpha value that denotes excess bandwidth associated with Nyquist filtering. The execution of a handshaking protocol and the assignment of the cable modem to a DOCSIS logical channel that supports proprietary features facilitate communication of the proprietary communication parameter between the CMTS and the cable modem.

### CROSS-REFERENCE TO RELATED APPLICATIONS

This application is related to co-pending, commonly-owned U.S. patent application Ser. No. 10/440,325, entitled “System, Method and Computer Program Product for Facilitating Communication Between Devices Implementing Proprietary Features in a DOCSIS-compliant Broadband Communication System,” filed May 19, 2003, the entirety of which is incorporated by reference as if set forth fully herein.

### BACKGROUND OF THE INVENTION

1. Field of the Invention

The present invention is generally directed to broadband communication systems. In particular, the present invention relates to broadband communication systems that comply with the Data Over Cable Service Interface Specification (DOCSIS), including but not limited to DOCSIS-compliant cable modem communication systems.

2. Background

Conventional cable modem systems utilize DOCSIS-compliant equipment and protocols to carry out the transfer of data packets between multiple cable modems at the customer premises and a cable modem termination system (CMTS) at the cable headend. The term DOCSIS (Data Over Cable System Interface Specification) generally refers to a group of specifications published by CableLabs that define industry standards for cable headend and cable modem equipment. In part, DOCSIS sets forth requirements and objectives for various aspects of cable modem systems including operations support systems, management, data interfaces, as well as network layer, data link layer, and physical layer transport for data over cable systems. The most current version of the DOCSIS specification is DOCSIS 2.0.

It has been observed, however, that the use of proprietary features or protocols that are not provided for, or permitted by, the DOCSIS specification may be advantageous within a DOCSIS-compliant cable modem system. For example, the modification of certain DOCSIS-defined physical (PHY) layer or Media Access Control (MAC) layer parameters and/or the use of different PHY or MAC technologies than those supported by DOCSIS may provide a variety of benefits. Such benefits can range from providing better system throughput, reducing latency, reducing the cost of the cable modem and/or the CMTS, providing a system with better signal integrity, providing improved utilization of the spectrum, reducing the area of either the cable modem or the CMTS, or providing better noise immunity.

Heretofore, such use of proprietary features that extend beyond DOCSIS has been avoided. This is due, in part, to the fact that the DOCSIS specification does not provide a mechanism for implementing proprietary features. Moreover, because conventional CMTS and cable modem equipment have been designed in accordance with the DOCSIS specification, the implementation of proprietary features has been avoided to ensure interoperability between cable modem system components.

Accordingly, what is desired is a system, method and computer program product that enables the use of proprietary features that are not provided for, or permitted by, the DOCSIS specification within a DOCSIS-compliant broadband communication system, such as a DOCSIS-compliant cable modem system. For example, the desired system, method and computer program product should support at least one proprietary communication parameter associated with bandwidth utilization that is not defined by, or encompasses values that are not provided for by, the DOCSIS specification. However, the desired system, method and computer program product should also be interoperable with DOCSIS in the sense that system components that support the proprietary features can exist on the same network with standard DOCSIS-compliant components that do not. Furthermore, the desired system and method should be implemented in a manner that requires minimal modification to the design of existing system components, such as the design of existing cable modem and CMTS equipment.

### BRIEF SUMMARY OF THE INVENTION

The present invention uses DOCSIS 2.0 logical upstream channels to support the use of features, protocols, and technologies that extend beyond the DOCSIS specification within a DOCSIS-compliant broadband communication system, such as a DOCSIS-compliant cable modem system, while ensuring interoperability with conventional DOCSIS-compliant equipment. In particular, and as will be described in more detail herein, embodiments of the invention provide a method, system and computer program product for facilitating communication between devices that implement at least one proprietary feature in a DOCSIS-compliant broadband communication system.

In particular, an embodiment of the present invention provides a method for improving channel efficiency in a broadband communication system that complies with a DOCSIS standard. In accordance with the method, a logical channel is established for communication between a first device, such as a CMTS, that supports at least one proprietary communication parameter associated with bandwidth utilization and other devices that support the at least one proprietary communication parameter. Registration information is then received from a second device, such as a cable modem, wherein the registration information indicates that the second device supports the at least one proprietary communication parameter. The second device is then assigned to the logical channel in response to receiving the registration information. The at least one proprietary communication parameter may include, but is not limited to, a modulation rate, a base rate, or an alpha value.

In another embodiment of the present invention, a CMTS for improving channel efficiency in a cable modem system that complies with a DOCSIS standard includes an upstream channel manager and a registration module. The upstream channel manager is adapted to establish a logical channel for communication with cable modems that support at least one proprietary communication parameter associated with bandwidth utilization. The registration module is adapted to receive registration information from a cable modem, wherein the registration information indicates that the cable modem supports the at least one proprietary communication parameter, and to assign the cable modem to the logical channel in response to receiving the registration information. The at least one proprietary communication parameter may include, but is not limited to, a modulation rate, a base rate, or an alpha value.

In another embodiment of the present invention, a computer program product is provided. The computer program product comprises a computer useable medium having computer program logic recorded thereon for enabling a processor to facilitate communication between devices in a broadband communication system that complies with a DOCSIS standard. The computer program logic comprises means for enabling the processor to establish a logical channel for communication between a first device, such as a CMTS, that implements at least one proprietary communication parameter associated with bandwidth utilization and other devices that support the at least one proprietary communication parameter. The computer program logic also comprises means for enabling the processor to receive registration information from a second device, such as a cable modem, wherein the registration information indicates that the second device supports the at least one proprietary communication parameter. The computer program logic further comprises means for enabling the processor to assign the second device to the logical channel in response to receiving the registration information. The at least one proprietary communication parameter may include, but is not limited to, a modulation rate, a base rate, or an alpha value.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts basic elements of an example DOCSIS-compliant cable modem communication system.

FIG. 2 depicts an example DOCSIS-compliant cable modem system that facilitates communication between devices implementing proprietary features in accordance with an embodiment of the present invention.

FIG. 3 illustrates a flowchart of a method for facilitating communication between devices implementing proprietary features in a DOCSIS-compliant cable modem system in accordance with an embodiment of the present invention.

FIG. 4 illustrates a flowchart of a method for establishing a logical channel that facilitates communication between devices implementing proprietary features in a DOCSIS-compliant cable modem system in accordance with an embodiment of the present invention.

FIG. 5 illustrates a format of a DOCSIS Upstream Channel Descriptor (UCD) message in accordance with the DOCSIS RFI Specification.

FIG. 6 illustrates a format of a MAC Management Header of a DOCSIS UCD message in accordance with the DOCSIS RFI Specification.

FIG. 7 illustrates a flowchart of a method for selectively sending a UCD message to devices that implement proprietary features in a DOCSIS-compliant cable modem system in accordance with an embodiment of the present invention.

FIG. 8 illustrates a flowchart of a method for selectively sending a UCD message to devices that implement proprietary features in a DOCSIS-compliant cable modem system in accordance with an embodiment of the present invention.

FIG. 9 illustrates a flowchart of an alternate method for establishing a logical channel that facilitates communication between devices implementing proprietary features in a DOCSIS-compliant cable modem system in accordance with an embodiment of the present invention.

FIG. 10 illustrates a flowchart of a method for registration of a device that implements proprietary features in a DOCSIS-compliant cable modem system in accordance with an embodiment of the present invention.

FIG. 11 is a diagram of channel spectrum use that demonstrates the relationship between symbol rate, spectrum width, and various communication parameters.

FIG. 12 is a diagram that compares the utilization of 1 MHz of spectrum by a conventional DOCSIS broadband communication system and by a communication system in accordance with an embodiment of the present invention.

FIG. 13 is a diagram that compares the utilization of a 720 MHz spectrum band by a conventional DOCSIS broadband communication system and by a communication system in accordance with an embodiment of the present invention.

FIG. 14 is a diagram that compares the utilization of a noisy 2.05 MHz band of spectrum by a conventional DOCSIS broadband communication system and by a communication system in accordance with an embodiment of the present invention.

FIG. 15 illustrates a flowchart of a method for establishing a logical channel that facilitates communication between devices implementing proprietary features in a DOCSIS-compliant broadband communication system in accordance with an embodiment of the present invention.

FIG. 16 illustrates an example processor-based system that may implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

A. Introduction to DOCSIS 2.0 Logical Channels

Common to all DOCSIS-compliant broadband data communication architectures is the transfer of data between a central location and many remote subscribers over a shared communications medium. The terms used to describe the central location vary depending on the type of communication architecture: for example, in cable modem systems, the central location is typically referred to as the headend, in broadband terrestrial fixed wireless systems, it is typically referred to as a wireless access termination system (WATS), and in two-way satellite communication systems, it is typically referred to as the satellite gateway. Terms used to describe subscriber equipment also vary depending on the type of communication architecture: for example, in cable modem systems, such equipment is typically referred to as a cable modem (CM), in broadband terrestrial fixed wireless systems, it is typically referred to as a wireless modem (WM), and in two-way satellite communication systems, it is typically referred to as a satellite modem (SM).

For the purposes of the description provided herein, terminology pertaining to cable modem systems will be used. However, as will be appreciated by persons skilled in the relevant art(s) based on the teachings provided herein, the present invention is not limited to cable modem systems, and may be implemented, for example, in any DOCSIS-compliant broadband communication system.

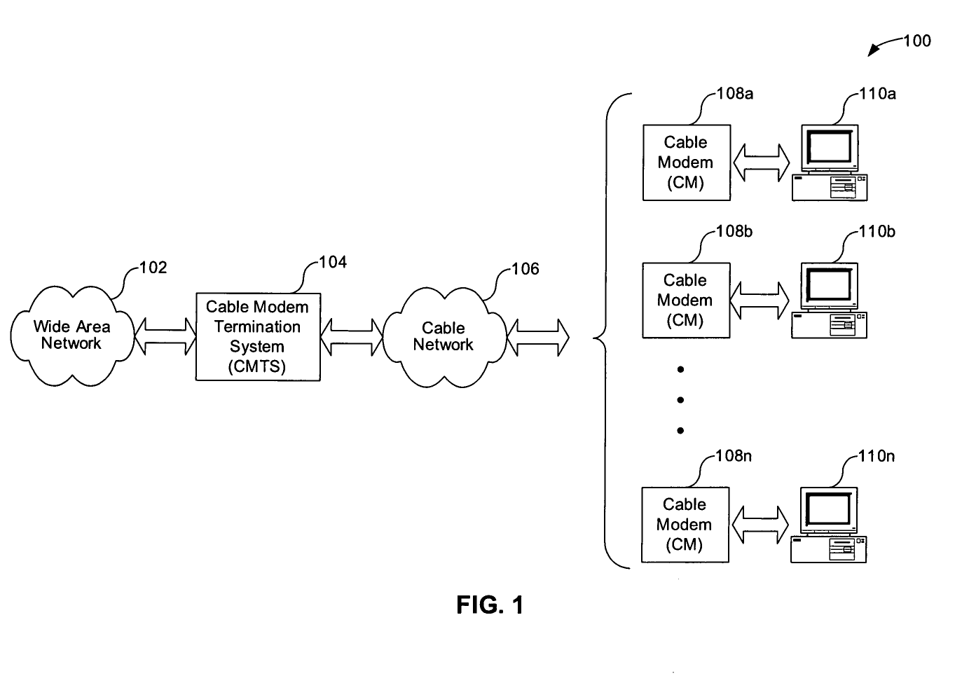

FIG. 1 depicts basic elements of an example DOCSIS-compliant cable modem system 100 in which an embodiment of the present invention may operate. In example system 100, a cable network 106, which typically comprises a hybrid fiber-coaxial (HFC) network, provides a point-to-multipoint topology for supporting the communication of data, such as IP packets, between a cable modem termination system (CMTS) 104 at the cable headend and multiple cable modems (CM) 108a-108n at various customer premises. As will be appreciated by persons skilled in the relevant art(s), CMTS 104 operates, in part, as an interface between cable network 106 and a wide area network (WAN) 102, and each of cable modems 108a-108n operates as an interface between cable network 106 and at least one corresponding customer premises equipment (CPE) 110a-10n.

Communication from CMTS 104 to cable modems 108a-108n is customarily referred to as “downstream” communication, and communication from cable modems 108a-108n to CMTS 104 is customarily referred to as “upstream” communication.

An example CMTS and an example cable modem are fully described in U.S. patent application Ser. No. 09/430,821 to Quigley et al., filed Oct. 29, 1999 and entitled “Cable Modem System”, the entirety of which is incorporated by reference as if set forth fully herein.

The DOCSIS Radio Frequency Interface (RFI) Specification defines three different radio frequency (RF) interfaces for cable modem systems: (1) the interface between each cable modem 108a-108n and cable network 106,
(2) the interface between CMTS 104 and cable network 106 in the downstream direction (toward the customer), and (3) the interface between CMTS 104 and cable network 106 in the upstream direction (traffic from the customer). The most recent version of the DOCSIS RFI Specification is version 2.0, denoted SP-RFIv2.0-103-021218 (hereinafter, “the DOCSIS RFI Specification”), the entirety of which is incorporated by reference herein.

One difference between DOCSIS 2.0 and earlier versions of the standard is that two different burst type formats are supported for upstream physical (PHY) layer transmissions between cable modems 108a-108n and CMTS 104. In particular, as specified by the DOCSIS RFI Specification, the upstream physical media dependent (PMD) sublayer can use either an FDMA/TDMA burst type format, also referred to as the “TDMA mode,” or an FDMA/TDMA/S-CDMA burst type format, also referred to as the “S-CDMA mode.” In further accordance with the DOCSIS RFI Specification, two types of TDMA modes are supported: DOCSIS 1.× TDMA and DOCSIS 2.0 TDMA, which is also referred to as “Advanced TDMA” or “A-TDMA.” Whether a cable modem transmits data using DOCSIS 1.× TDMA mode, A-TDMA mode, or S-CDMA mode is configured by the CMTS through the transmission of DOCSIS MAC (Media Access Control) Management Messages.

FDMA (frequency division multiple access) indicates that multiple RF channels are assigned in the upstream band. In accordance with FDMA, a cable modem transmits on a single RF channel unless reconfigured to change channels. TDMA (time division multiple access) indicates that upstream transmissions have a burst nature. In accordance with TDMA, a given RF channel is shared by multiple cable modems via the dynamic assignment of time slots. S-CDMA (synchronous code division multiple access) indicates that multiple cable modems can transmit simultaneously on the same RF channel and during the same TDMA time slot, while being separated by different orthogonal codes.

To create a system to allow the above-described TDMA and S-CDMA modes to co-exist, the DOCSIS 2.0 RFI specification has introduced the concept of a logical channel. Prior to DOCSIS 2.0, each upstream channel was allocated its own channel frequency. Thus, all channels could be viewed as physical channels. In DOCSIS 2.0, multiple upstream channels, referred to as logical channels, can share the same RF spectrum. Thus, a physical upstream channel may support multiple logical upstream channels. Each logical channel is identified by a unique channel ID. The CMTS transmits an associated Upstream Channel Descriptor (UCD) and MAP message to completely describe the channel.

DOCSIS 2.0 provides four distinct types of logical upstream channels: (1) DOCSIS 1.× upstream channels that support no A-TDMA features; (2) mixed upstream channels that support DOCSIS 1.× and A-TDMA bursts; (3) A-TDMA only upstream channels that cannot support DOCSIS 1.× cable modems; and (4) S-CDMA upstream channels that support only cable modems operating in S-CDMA mode. All valid logical upstream channels must fall into one of these four categories.

The use of logical channels provides several direct benefits to Multi-System Operators (MSOs) operating DOCSIS 2.0-compliant cable modem systems. For example, by permitting multiple logical channels that support different burst type formats to share a single physical channel, spectrum utilization may be improved and upstream bandwidth may be conserved. Furthermore, the use of logical channels provides better overall system controllability.

B. Facilitating Communication Between Devices Implementing Proprietary Features in Accordance with an Embodiment of the Present Invention

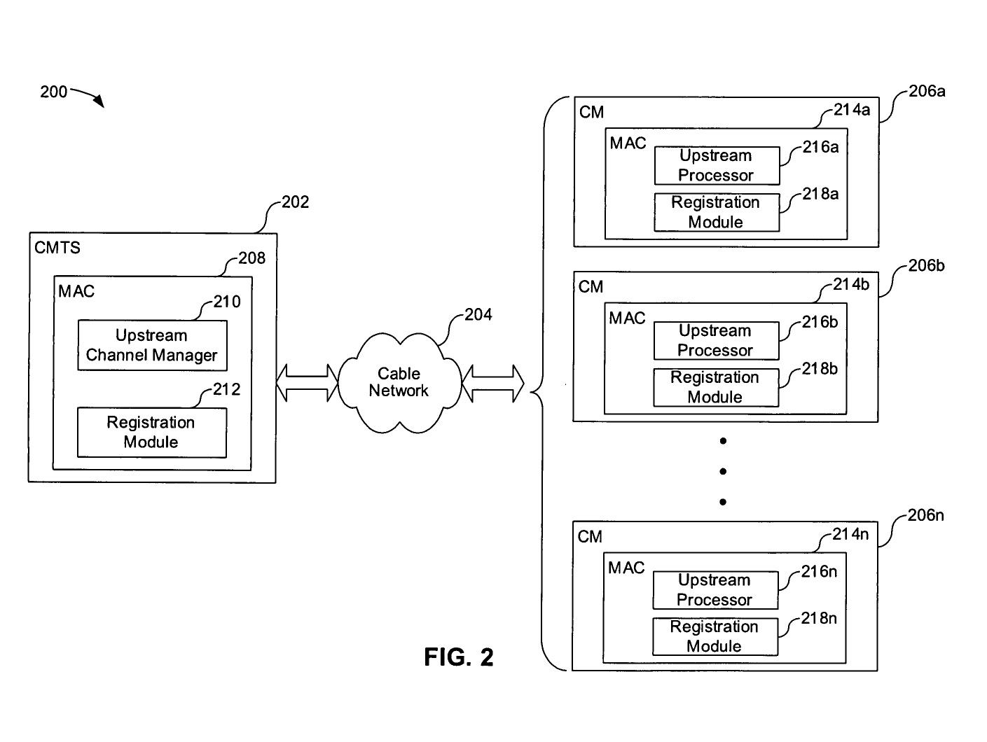

FIG. 2 depicts an example cable modem system 200 that implements a method for facilitating communication between devices implementing proprietary features in a DOCSIS-compliant cable modem system in accordance with an embodiment of the present invention. As shown in FIG. 2, cable modem system 200 includes a CMTS 202 that is communicatively coupled via a cable network 204 to a plurality of cable modems 206a-206n. For the purposes of this example, it is assumed that CMTS 202 and cable modems 206a-206n are each configured to support proprietary features that are not provided for, or permitted by, DOCSIS.

As shown in FIG. 2, CMTS 202 comprises a Media Access Control (MAC) sublayer 208, which in turn comprises an upstream channel manager 210 and a registration module 212. Upstream channel manager 210 is configured to perform administrative functions related to the management of upstream communication from cable modems 206a-206n to CMTS 202, including but not limited to establishing logical upstream channels. In the embodiment depicted in FIG. 2, upstream channel manager 210 is implemented as part of CMTS MAC 208; however, the invention is not so limited. For example, upstream channel manager 210 can also be implemented, in whole or in part, as part of an entity external to CMTS 202 and communicatively coupled thereto, such as a network management system external to CMTS 202 and communicatively coupled thereto.

Registration module 212 is configured to perform the CMTS portion of a cable modem initial ranging and registration protocol described in the DOCSIS RFI Specification, as well as the CMTS portion of a proprietary cable modem registration protocol which will be described in more detail herein.

As will be understood by persons skilled in the relevant art(s) from the teachings provided herein, CMTS MAC 208, and each of upstream channel manager 210 and registration module 212 may be readily implemented in hardware, software, or a combination of hardware and software. For example, based on the teachings provided herein, a person skilled in the relevant art could implement the functions of CMTS MAC 208, and the functions of each of upstream channel manager 210 and registration module 212, via a combination of one or more application-specific integrated circuits and a processor core for implementing software commands stored in one or more attached memories. However, this example is not limiting, and other implementations are within the scope and spirit of the present invention.

As also depicted in FIG. 2, each cable modem 206a-206n comprises a respective MAC sublayer 214a-214n, each of which in turn comprises a respective upstream processor 216a-216n and a respective registration module 218a-218na. Each upstream processor 216a-216n is configured to perform functions related to the transmission of data over a logical upstream channel from the cable modem to CMTS 202. Each registration module 216a-216n is configured to perform the cable modem portion of a cable modem initial ranging and registration protocols described in the DOCSIS RFI Specification, as well as the cable modem portion of a proprietary cable modem registration protocol which will be described in more detail herein.

As will be understood by persons skilled in the relevant art(s) from the teachings provided herein, each cable modem MAC 214a-214n, and each respective upstream processor 216a-216n and respective registration module 218a-218n, may be readily implemented in hardware, software, or a combination of hardware and software. For example, based on the teachings provided herein, a person skilled in the relevant art could implement the functions of each cable modem MAC 214a-214n, and each respective upstream processor 216a-216n and respective registration module 218a-218n, via a combination of one or more application-specific integrated circuits and a processor core for implementing software commands stored in one or more attached memories. However, this example is not limiting, and other implementations are within the scope and spirit of the present invention.

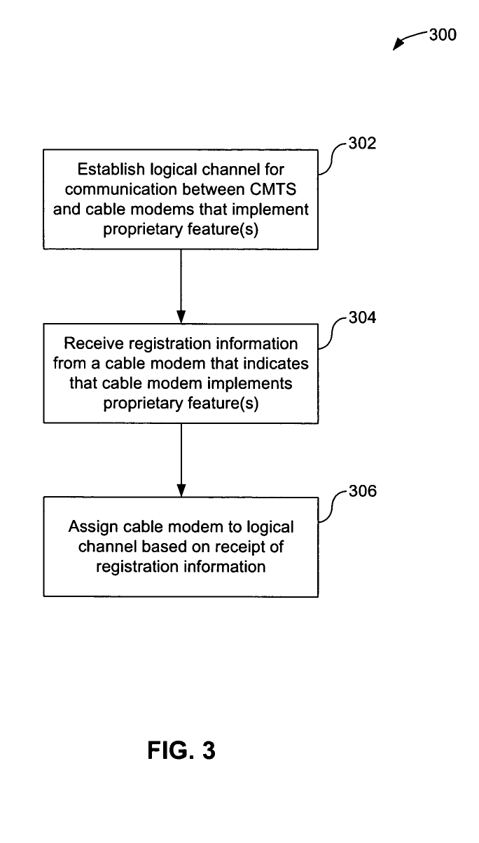

FIG. 3 illustrates a flowchart 300 of a method for facilitating communication between devices implementing proprietary features in a DOCSIS-compliant cable modem system in accordance with an embodiment of the present invention. The invention, however, is not limited to the description provided by the flowchart 300. Rather, it will be apparent to persons skilled in the relevant art(s) from the teachings provided herein that other functional flows are within the scope and spirit of the present invention.

Flowchart 300 will be described with continued reference to example cable modem system 200 described above in reference to FIG. 2. The invention, however, is not limited to that embodiment.

The method of flowchart 300 begins at step 302, in which a logical upstream channel is established to support future communication between CMTS 202 and cable modems that implement one or more proprietary features, such as one or more of cable modems 206a-206n. Various methods for establishing the logical channel will be described in more detail herein. At step 304, CMTS 202 receives registration information from a cable modem, such as one of cable modems 206a-206n, that indicates that the cable modem implements at least one of the one or more proprietary features. The protocol by which this registration is carried out will also be described in more detail herein. Finally, at step 306, CMTS 202 assigns the cable modem to the logical channel based on the receipt of the registration information, at which point the cable modem may transmit data to CMTS 202 over the logical channel.

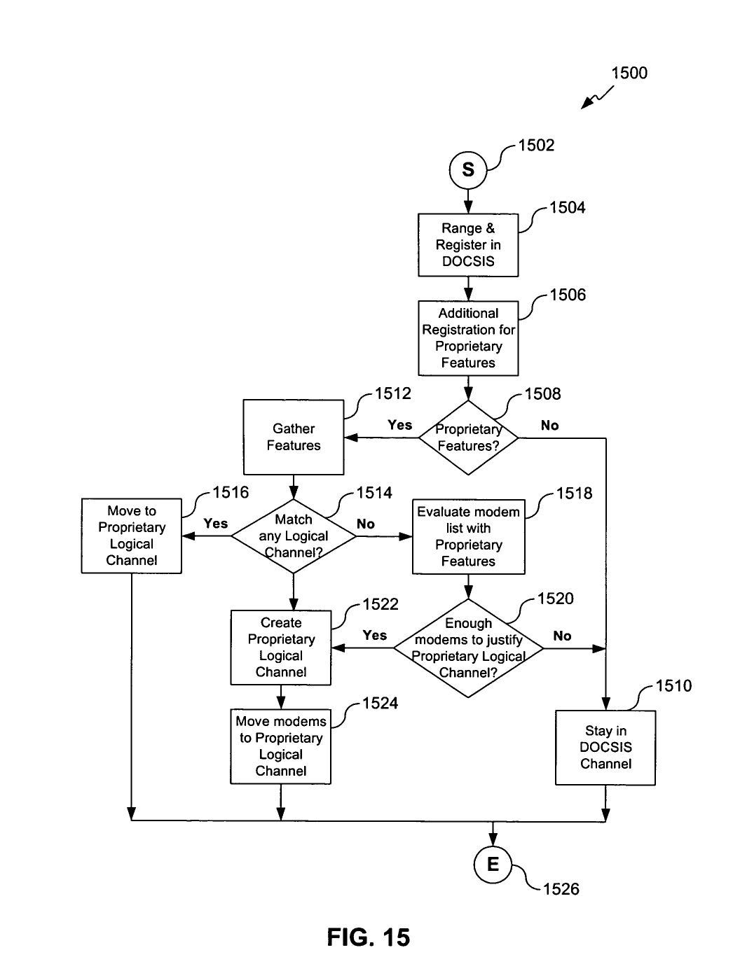

FIG. 15 illustrates a flowchart 1500 of a method for setting up a logical channel that facilitates communication between devices implementing proprietary features in a DOCSIS-compliant broadband communication system in accordance with an embodiment of the present invention. The invention, however, is not limited to the description provided by the flowchart 1500. Rather, it will be apparent to persons skilled in the relevant art(s) from the teachings provided herein that other functional flows are within the scope and spirit of the present invention. The flowchart 1500 will be described with continued reference to example cable modem system 200 described above in reference to FIG. 2. The invention, however, is not limited to that embodiment.

The method of flowchart 1500 begins at step 1502 and is invoked when a cable modem 206 attempts to register onto the system. Once invoked, the algorithm proceeds to step 1504, in which CMTS 202 and cable modem 206 complete standard DOCSIS ranging and registration. Upon completion of standard DOCSIS ranging and registration, the algorithm proceeds to step 1506 in which CMTS 202 communicates with cable modem 206 to determine whether cable modem 206 supports any proprietary features. This communication may be implemented via an extended DOCSIS registration in which information is transmitted using vendor type/length/value (TLV) tuples, or via a standard communication protocol such as Internet Protocol (IP). In either case, CMTS 206 queries cable modem 206 for proprietary features.

The algorithm then proceeds to step 1508, in which CMTS 202 determines if cable modem 206 has any proprietary features. If the cable modem does not have proprietary features, the algorithm proceeds to step 1510, which keeps the modem in a standard DOCSIS channel and then completes the algorithm at step 1526. If cable modem 206 has proprietary features, then the algorithm proceeds to step 1512.

At step 1512, CMTS 202 gathers a list of these proprietary features from cable modem 206. The algorithm then proceeds to step 1514, in which CMTS 202 determines if the feature list of cable modem 206 allows it to be placed in an existing logical channel that supports proprietary features, or “proprietary logical channel.” If so, the algorithm proceeds to step 1516, in which CMTS 202 assigns cable modem 206 to that proprietary channel, and then completes the algorithm at step 1526.

If not, the algorithm proceeds to step 1518, in which CMTS 202 evaluates all the currently registered modems that have proprietary features. The algorithm then proceeds to step 1520, in which CMTS 202 determines if a new logical channel should be created for these modems. For example, this determination may be based on whether the number of currently registered modems that have proprietary features has reached some predetermined number; however, different or additional factors may be taken into account.

If a new logical channel should not be created, then the algorithm proceeds to step 1510, in which CMTS 202 leaves cable modem 206 in a standard DOCSIS channel and exits the algorithm. If a new logical channel should be created, the algorithm proceeds to step 1522, in which CMTS 202 creates a new logical channel. CMTS 202 may accomplish this by changing an existing logical channel, by removing an existing logical channel and creating a new logical channel, or by simply creating a new logical channel. The algorithm then proceeds to step 1524, in which CMTS 202 moves all cable modems that should use this new logical channel to that channel. Upon completion of moving the cable modems, the algorithm ends at step 1526.

C. Establishing a Logical Channel in Accordance with an Embodiment of the Present Invention

In accordance with an embodiment of the present invention, a CMTS establishes a DOCSIS 2.0 logical upstream channel to facilitate communication between the CMTS and cable modems that support one or more proprietary features. The mechanism provided by the DOCSIS RFI Specification for establishing a logical upstream channel is a MAC Management Message, termed an Upstream Channel Descriptor (UCD), which is broadcast by the CMTS to all cable modems on the network.

However, in accordance with an embodiment of the present invention, the UCD message generated by the CMTS includes parameters not provided for or permitted by DOCSIS that are necessary in order to adequately define the proprietary logical upstream channel. Receipt of such modified UCD messages by cable modems that are not configured to process these parameters may cause these cable modems to malfunction. This interoperability issue is addressed by methods that will now be described.

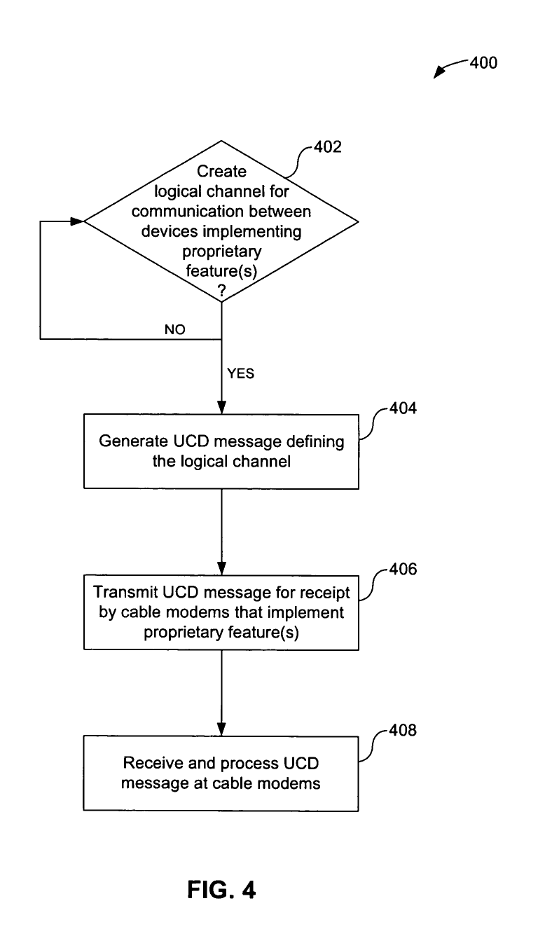

FIG. 4 illustrates a flowchart 400 of a method for establishing a logical channel that facilitates communication between devices implementing proprietary features in a DOCSIS-compliant cable modem system in accordance with an embodiment of the present invention. The invention, however, is not limited to the description provided by the flowchart 400. Rather, it will be apparent to persons skilled in the relevant art(s) from the teachings provided herein that other functional flows are within the scope and spirit of the present invention.

The flowchart 400 will be described with continued reference to example cable modem system 200 described above in reference to FIG. 2. The invention, however, is not limited to that embodiment.

The method of flowchart 400 begins at step 402 in which upstream channel manager 210 determines whether or not a logical channel for communication between devices implementing proprietary features should be created. Upstream channel manager 210 may make this determination based on a variety of factors including, but not limited to, a default network configuration, commands from a system administrator, or registration by one or more cable modems that support extended protocols.

If the upstream channel manager 210 determines that a logical channel should be created for communication between devices that implement proprietary features, then upstream channel manager 210 generates a UCD message defining the logical channel as shown at step 404.

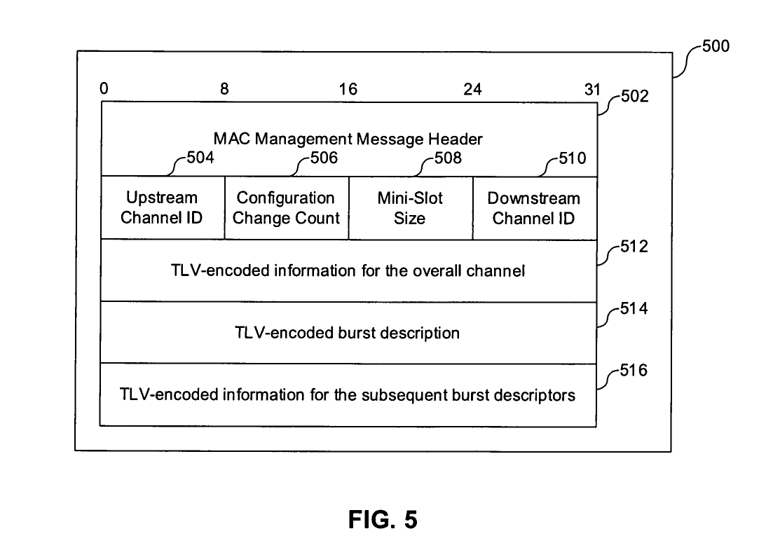

FIG. 5 is provided to illustrate a format 500 of a DOCSIS UCD message in accordance with the DOCSIS RFI Specification. As shown in FIG. 5, the DOCSIS UCD message includes a plurality of fields, including a MAC Management Message Header 502, an Upstream Channel Identifier (ID) 504 that uniquely identifies the logical channel, a Configuration Change Count 506, a Minislot Size 508, a Downstream Channel ID 510, TLV-encoded Information for the Overall Channel 512, TLV-encoded Burst Description 514, and TLV-encoded Information for the Subsequent Burst Descriptors 516. A description of each of these fields is provided in the DOCSIS RFI Specification (Ver. SP-RFIv2.0-103-021218), which is incorporated by reference in its entirety as if set forth fully herein.

In accordance with an embodiment of the present invention, certain fields within the UCD message generated at step 404 are modified to include values that are not provided for or permitted by DOCSIS, but are necessary to define the logical channel used for communication between devices implementing proprietary features. Such modified fields may be included, for example, as part of the TLV-encoded Information for the Overall Channel 512, the TLV-encoded Burst Description 514, and/or the TLV-encoded Information for the Subsequent Burst Descriptors 516.

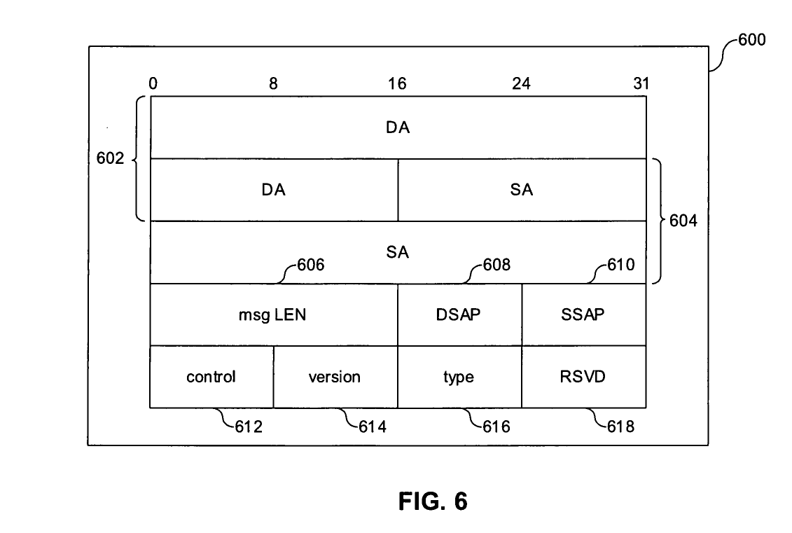

FIG. 6 is provided to illustrate a format 600 of the MAC Management Message Header 502 of UCD message 500 in accordance with the DOCSIS RFI Specification. As shown in FIG. 6, the MAC Management Header 502 includes a plurality of fields, including a Destination Address (DA) 602, a Source Address (SA) 604, a Message Length (msgLEN) 606, a Destination Service Access Port (DSAP) 608, a Source Service Access Port (SSAP) 610, a Control field 612, a Version field 614, a Type field 616, and a Reserved (RSVD) field 618. A description of each of these fields is also provided in the DOCSIS RFI Specification, which is incorporated by reference in its entirety as if set forth fully herein.

In accordance with an embodiment of the present invention, upstream channel manager 210 generates a UCD message at step 404 that has a combination of Version field 614 and Type field 616 that is permitted by the DOCSIS RFI Specification. The DOCSIS RFI Specification provides that for DOCSIS 2.0 only upstream channels, the CMTS must use a value of 3 for Version field 614 and a value of 29 for Type field 616. For all other logical upstream channels, the CMTS must use a value of 1 for Version field 614 and a value of 2 for Type field 616.

At step 406, CMTS 402 transmits the UCD message generated during step 404 downstream for receipt by only those cable modems that implement the proprietary features. This step is necessary because the UCD message may include fields that have been modified to include values that are not provided for, or permitted by, the DOCSIS 2.0 RFI Specification, but are necessary to adequately define the logical channel that supports communication between devices implementing proprietary features as discussed above. Therefore, it is essential to ensure that such modified UCD messages are not processed by cable modems that do not implement the proprietary features, since such processing may cause those cable modems to malfunction.

At step 408, each of the cable modems 406a-406n receives the UCD message. Upstream processors 416a-416n within respective cable modems 406a-406n then process the UCD message to obtain information necessary for transmitting data over the logical upstream channel defined by the UCD message.

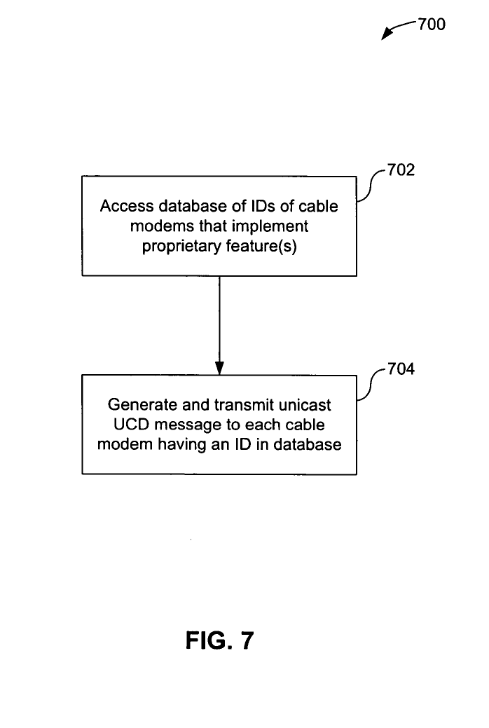

FIG. 7 illustrates a flowchart 700 of one method for implementing step 406 of flowchart 400. As discussed above, step 406 entails transmitting a UCD message downstream for receipt by only those cable modems that implement proprietary features. The invention, however, is not limited to the description provided by the flowchart 700. Rather, it will be apparent to persons skilled in the relevant art(s) from the teachings provided herein that other functional flows are within the scope and spirit of the present invention.

The method of flowchart 700 begins at step 702, in which upstream channel manager 210 accesses a database of unique identifiers (IDs) of cable modems that implement proprietary features. In an embodiment, CMTS 402 determines whether a cable modem implements proprietary features during a cable modem registration protocol, which is described in more detail below. Cable modems so identified during registration are added to the database. In an embodiment, the cable modem ID comprises a MAC address of the cable modem. The database of cable modem IDs is preferably maintained in a memory internal to CMTS MAC 208, although the invention is not so limited.

At step 704, upstream channel manager 210 generates a separate unicast UCD message for each cable modem having an ID in the database. Each unicast UCD message is then transmitted downstream for receipt by a corresponding cable modem. By addressing the UCD message to only those cable modems that implement the proprietary features, this method ensures that cable modems that do not support those features will not process a UCD message that includes parameters not provided for or permitted by DOCSIS.

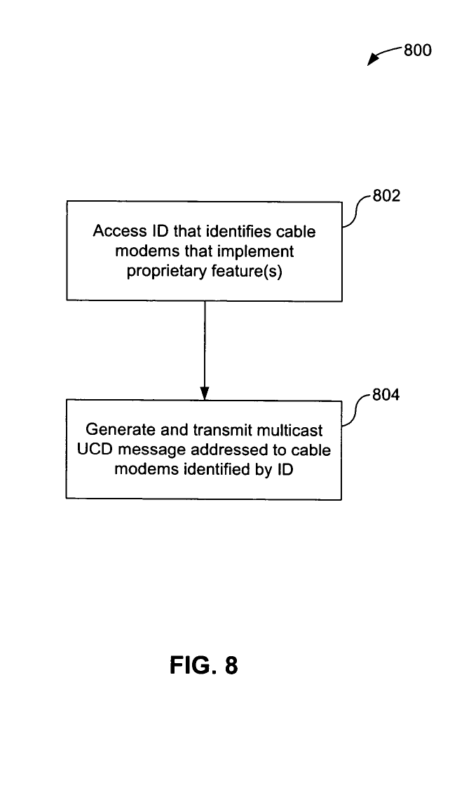

FIG. 8 illustrates a flowchart 800 of an alternate method for implementing step 406 of flowchart 400. As shown in FIG. 8, the method begins at step 802, in which upstream channel manager 210 accesses a unique identifier of cable modems that implement proprietary features. In an embodiment, the unique identifier comprises a multicast address that identifies one or more cable modems that implement proprietary features. In an embodiment, CMTS 402 assigns the multicast address to cable modems that implement proprietary features during a cable modem registration protocol, which will be described in more detail below.

At step 804, upstream channel manager 210 generates a multicast UCD message addressed to each cable modem encompassed by the identifier. The multicast UCD message is then transmitted downstream to be received by only those cable modems. By addressing the UCD message to only those cable modems that implement the proprietary features, this method ensures that cable modems that do not support those features will not process a UCD message that includes parameters not provided for or permitted by DOCSIS.

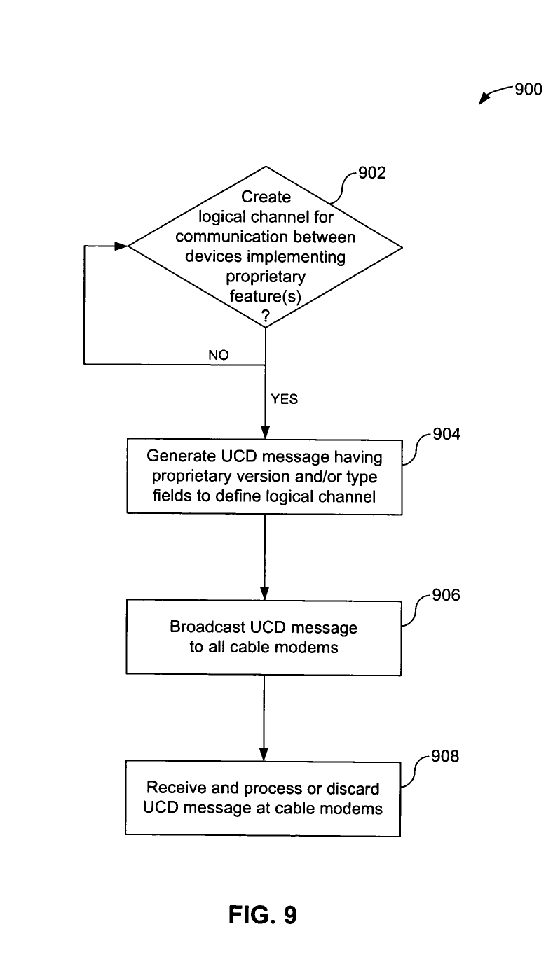

FIG. 9 illustrates a flowchart 900 of an alternate method for establishing a logical channel that facilitates communication between devices implementing proprietary features in a DOCSIS-compliant cable modem system in accordance with an embodiment of the present invention. The invention, however, is not limited to the description provided by the flowchart 900. Rather, it will be apparent to persons skilled in the relevant art(s) from the teachings provided herein that other functional flows are within the scope and spirit of the present invention.

The flowchart 900 will also be described with continued reference to example cable modem system 200 described above in reference to FIG. 2. The invention, however, is not limited to that embodiment.

The method of flowchart 900 begins at step 902 in which upstream channel manager 210 determines whether or not a logical channel for communication between devices implementing proprietary features should be created. If the upstream channel manager 210 determines that such a logical channel should be created, then upstream channel manager 210 generates a UCD message defining the logical channel as shown at step 904. As discussed above in reference to step 404 of flowchart 400, certain fields within the UCD message are modified to include values that are not provided for or permitted by DOCSIS, but are necessary to define the logical channel used for communication between devices implementing proprietary features.

Unlike the UCD message generated at step 404 of flowchart 400, however, the UCD message generated at step 904 has a combination of Version field 714 and Type field 716 that is not permitted by the DOCSIS RFI Specification, but will nevertheless be recognized and accepted by cable modems that implement proprietary features. Thus, the method of flowchart 900 assumes that upstream processors 216a-216n within cable modems 206a-206n are configured to accept UCD messages having a Version and Type that are different than those permitted by the DOCSIS RFI Specification.

In particular, the DOCSIS RFI Specification provides that for DOCSIS 2.0 only upstream channels, the CMTS must use a value of 3 for Version field 714 and a value of 29 for Type field 716. For all other logical upstream channels, the CMTS must use a value of 1 for Version field 714 and a value of 2 for Type field 716. Thus, in accordance with the method of flowchart 900, the UCD message has a combination of Version field 714 and Type field 716 that is not[3, 29] or[1, 2], but is some other set of values that will be recognized only by cable modems that implement proprietary features.

At step 906, CMTS 202 broadcasts the UCD message generated during step 904 downstream to all cable modems on the network.

Although all cable modems on the network will receive the UCD message, only those cable modems that implement proprietary features and are configured to recognize and accept UCD messages having the non-conforming Version and Type fields will process the UCD message, as shown at step 908. All other cable modems will discard the UCD messages for having an improper Version and Type field combination, thereby ensuring that cable modems that do not support proprietary features will not process a UCD message that includes parameters not provided for or permitted by DOCSIS.

D. Cable Modem Registration in Accordance with an Embodiment of the Present Invention

In accordance with an embodiment of the present invention, it is essential that a CMTS that implements proprietary features be aware of each cable modem on the DOCSIS-compliant network that also implements those features. As will be described in more detail herein, this may be achieved by implementing a proprietary cable modem registration protocol that is an extension of the standard DOCSIS cable modem registration protocol. The protocol enables a CMTS to assign cable modems that implement proprietary features to a logical channel dedicated to communication with devices that implement those features.

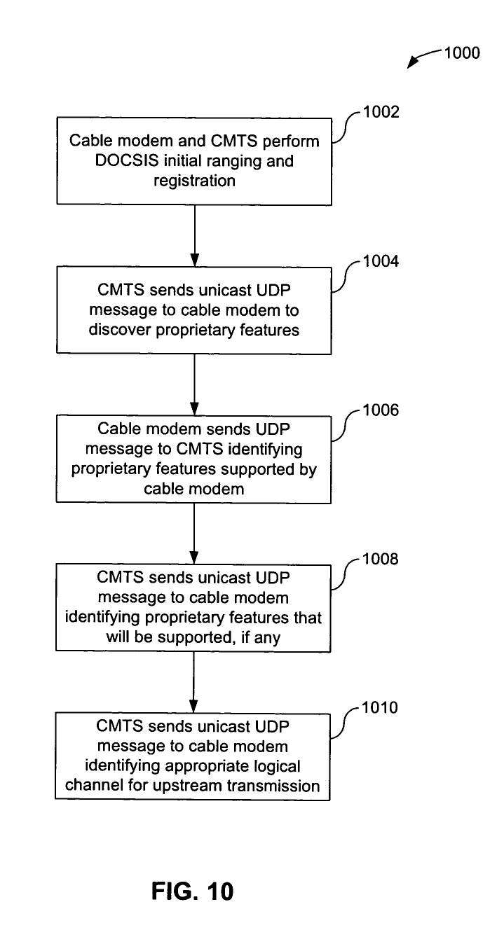

FIG. 10 illustrates a flowchart 1000 of a method for registration of a device that implements proprietary features in a DOCSIS-compliant cable modem system in accordance with an embodiment of the present invention. The invention, however, is not limited to the description provided by the flowchart 1000. Rather, it will be apparent to persons skilled in the relevant art(s) from the teachings provided herein that other functional flows are within the scope and spirit of the present invention.

The flowchart 1000 will be described with continued reference to example cable modem system 200 described above in reference to FIG. 2. In particular, the flowchart 1000 will be described with reference to an exchange of information between CMTS 202 and cable modem 206a. The invention, however, is not limited to this embodiment.

The method of flowchart 1000 begins at step 1002, in which cable modem 206a and CMTS 202 perform initial ranging and registration in accordance with the standard protocols set forth in the DOCSIS RFI Specification, which are well known in the art. In an embodiment, registration module 212 within CMTS MAC 208 generates messages for the CMTS portion of the protocol, while registration module 218a within cable modem MAC 214a generates messages for the cable modem portion of the protocol.

As shown at step 1004, after standard DOCSIS initial ranging and registration has completed, CMTS 202 generates and transmits at least one unicast UDP message to cable modem 206a to discover if cable modem 206a supports any proprietary features and to indicate its own support of proprietary features. In an embodiment, registration module 212 within CMTS MAC 208 generates the unicast UDP message using the MAC address of cable modem 206a as the destination address.

At step 1006, cable modem 206a receives the unicast UDP message from CMTS 202 and, in response, sends a UDP message to CMTS 202 identifying the proprietary features that are supported by the cable modem 206a. In an embodiment, registration module 218a within cable modem MAC 214a generates this UDP message.

At step 1008, CMTS 202 receives the UDP message transmitted by cable modem 206a in step 1006 and, in response, transmits a second unicast UDP message to cable modem 206a identifying the proprietary features that will be supported during communication with CMTS 202. As will be appreciated by persons skilled in the relevant art(s), the proprietary features that can be implemented for communication between CMTS 202 and cable modem 206a will be one or more of those features that are found in the intersection of the CMTS proprietary feature set and the cable modem proprietary feature set. In an embodiment, registration module 212 within CMTS MAC 208 generates the second unicast UDP message.

At step 1010, CMTS 202 sends a third unicast message to cable modem 206a identifying the appropriate logical channel for upstream transmission, wherein the logical channel supports one or more proprietary features implemented by both CMTS 202 and cable modem 206a. In an alternate embodiment, the unicast UDP messages sent by CMTS 202 in steps 1008 and 1010 are combined into a single unicast UDP message.

The above-described cable modem registration method ensures that cable modems implementing proprietary features will only transmit in logical upstream channels dedicated to devices that implement those features. Moreover, once a cable modem has been assigned to a logical upstream channel, the CMTS will no longer have to determine whether or not the cable modem supports proprietary features or which features are supported, since its feature set can be deduced based on transmission over a particular logical upstream channel.

E. Utilization of Proprietary Communication Parameters to Improve Channel Efficiency in Accordance with an Embodiment of the Present Invention

By facilitating the use of proprietary features that are not provided for or permitted by the DOCSIS specification within a DOCSIS-compliant broadband communication system, an embodiment of the present invention can accomplish many things that a conventional DOCSIS communication system cannot. For example, an embodiment of the present invention can improve upstream channel efficiency as compared to a conventional DOCSIS communication system. As will be described in more detail herein, this can be achieved by providing support for one or more proprietary communication parameters associated with bandwidth utilization that are not defined by, or that encompass values that are not provided for by, the DOCSIS specification.

In accordance with the DOCSIS RFI Specification, a CMTS communicates a modulation rate for an upstream channel to one or more cable modems through the transmission of a UCD MAC Management Message. With reference to the example DOCSIS UCD message depicted in FIG. 5, the modulation rate is communicated as part of the TLV-encoded information for the overall channel 512, having a type of 1 and a length of 1. The valid values for the modulation rate in a DOCSIS 2.0 communication system are 1, 2, 4, 8, 16 or 32 for communication in an A-TDMA mode, 1, 2, 4, 8 or 16 for communication in a TDMA mode, and 8, 16, or 32 for communication in an S-CDMA mode.

The modulation rate determines the bandwidth of spectrum used by the channel. The channel spectrum used may be calculated in accordance with the following equation:
CS=MR*BR*(1+α) (Equation 1)
where CS represents the channel spectrum used, or upstream channel bandwidth, MR represents the modulation rate, BR represents the base rate, and a represents the alpha value, which denotes excess bandwidth associated with Nyquist filtering.

For a conventional DOCSIS 2.0 communication system, the base rate is fixed at 160,000 (160K) and the value of alpha is fixed at 0.25. The value of alpha is fixed due to the Nyquist filter selected for the DOCSIS upstream channels. Table 1 shows each of the various modulation rates that may be selected for each burst type format and the amount of spectrum used by each selection. As illustrated by Table 1, there are only six different values for channel bandwidths.

TABLE 1
DOCSIS UPSTREAM CHANNEL WIDTHS

| Modulation Rate (MR) | S-CDMA | A-TDMA | TDMA |
|---|---|---|---|
| 1 | N/A | 200 KHz | 200 KHz |
| 2 | N/A | 400 KHz | 400 KHz |
| 4 | N/A | 800 KHz | 800 KHz |
| 8 | 1.6 MHz | 1.6 MHz | 1.6 MHz |
| 16 | 3.2 MHz | 3.2 MHz | 3.2 MHz |
| 32 | 6.4 MHz | 6.4 MHz | N/A |

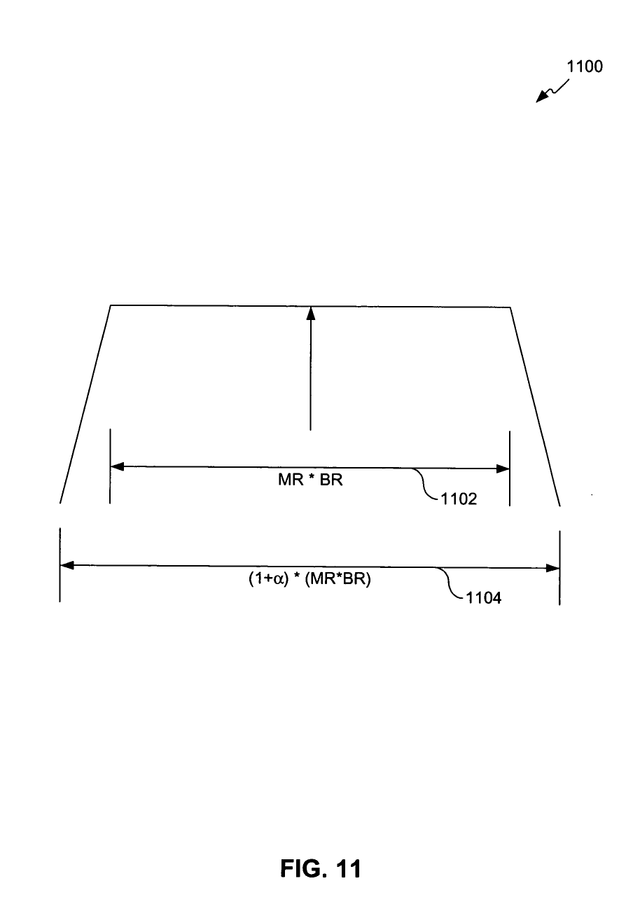

The symbol rate for each channel is equal to the modulation rate times the base rate. This is demonstrated by Equation 2:
SR=MR*BR (Equation 2)
in which SR=symbol rate, MR=modulation rate, and BR=base rate. This is a measurement of the rate at which information is being sent over the channel. FIG. 11 provides a diagram 1100 of channel spectrum use that demonstrates the relationship between symbol rate 1102, spectrum width 1104 and the parameters MR, BR and alpha.

An embodiment of the present invention can improve the total efficiency of the sum of the upstream channels in a DOCSIS-compliant broadband communication system. As will be described in more detail herein, this is achieved by supporting one or more proprietary communication parameters associated with spectrum utilization that are not defined by, or that encompass values that are not provided for by DOCSIS. These parameters may include a modulation rate, a base rate, or an alpha value.

1. Increasing the Number of Permissible Modulation Rates in Accordance with an Embodiment of the Present Invention

An embodiment of the present invention supports more modulation rates than those permitted by the DOCSIS RFI Specification. By increasing the number of permissible modulation rates, statistical multiplexing may be more effectively implemented in a communication system. In accordance with the principle of statistical multiplexing, two or more smaller bands of spectrum are combined into a single larger band, with the result that the larger band is more efficient. For example, if a channel consisting of single small band of spectrum becomes overrun with traffic, latency increases. As the latency rises, the channel becomes more inefficient. Eventually, the channel will have to drop packets. However, if another small band of spectrum is fairly idle, the system may have the capacity for this overrun. By combining the two bands into a single band, the problem may be solved.

As noted above, DOCSIS provides a limited set of modulation rates. In a DOCSIS communication system, combining two channels having different modulation rates is not always acceptable. If the modulation rates of two bands of spectrum are identical, then they can be combined; otherwise, they cannot. By allowing more modulation rates, an embodiment of the present invention can enhance the ability of a communication system to leverage statistical multiplexing.

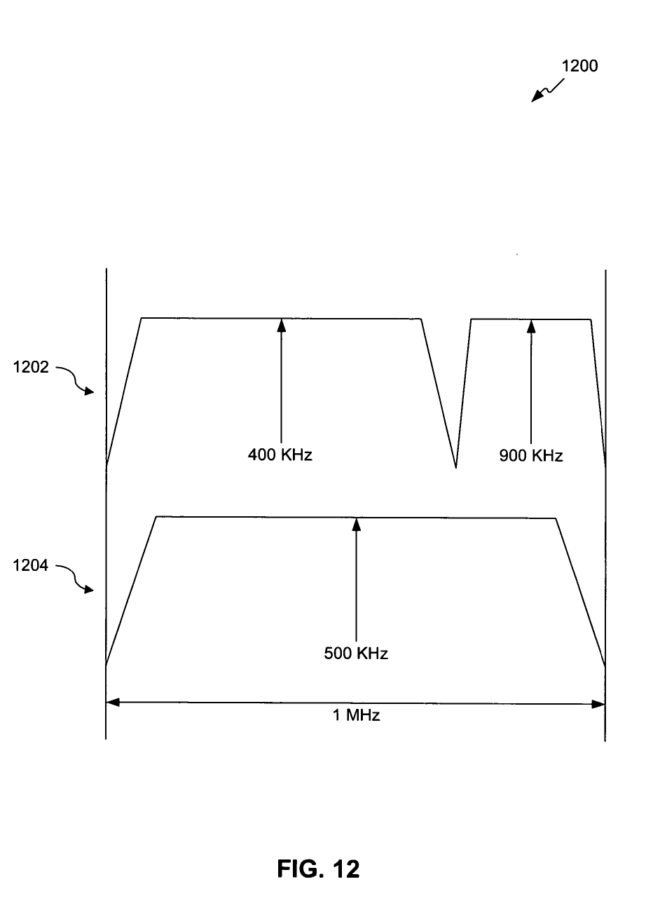

FIG. 12 is a diagram 1200 that illustrates the utilization of 1 MHz of spectrum by a conventional DOCSIS communication system and the utilization of the same spectrum by a communication system in accordance with an embodiment of the present invention. The DOCSIS approach, denoted 1202, consists of the creation of an 800 MHz wide channel (MR=4) centered 400 KHz into the 1 MHz of spectrum and a 200 KHz wide channel (MR=1) centered 900 MHz into the 1 MHz of spectrum. Alternatively, the conventional DOCSIS communication system could reorganize the channels such that the narrower channel is centered at 100 KHz and the wider channel is centered at 600 KHz into the 1 MHz of spectrum. From a channel efficiency viewpoint, either solution provides the same performance.

Given the limited number of modulation rates permitted by DOCSIS, either of these solutions will out-perform all other DOCSIS solutions. For example, instead of generating two channels to fill the 1 MHz band of spectrum, the conventional DOCSIS communication system could use three, four or five channels to fill the spectrum. However, increasing the number of channels in this manner would reduce the benefit of statistical multiplexing.

To derive the greatest benefit from statistical multiplexing, a communication system in accordance with an embodiment of the present invention could create a single channel solution, denoted 1204 in FIG. 12. In this example, maintaining a base rate of 160 KHz and an alpha value of 0.25, the communication system can utilize a modulation rate of 5, which is a value that is not permitted by DOCSIS, to create a single 1 MHz channel centered at 500 KHz. This is demonstrated by the following application of Equation 1, in which MR=5, BR 160 KHz and α=0.25:
CS=5*160KHz*(1+0.25)=1000KHz or 1MHz
Thus, an embodiment of the present invention that supports additional modulation rates beyond those permitted by DOCSIS will allow system spectrum to be used more efficiently. For example, a communication system that allows modulation rates to be integers rather than only powers of two will permit system spectrum to be used more efficiently. Indeed, the more modulation rates that are supported, the more the spectrum efficiency of the system may be enhanced.

2. Use of Variable Base Rates in Accordance with an Embodiment of the Present Invention

An alternative embodiment of the present invention utilizes a variable base rate to leverage statistical multiplexing. As noted elsewhere herein, a conventional DOCSIS communication system utilizes a fixed base rate of 160 KHz. By permitting the base rate to be variable, an embodiment of the present invention provides more flexibility in terms of spectrum utilization. For example, with further reference to FIG. 12, the preferred spectrum utilization 1204 may be achieved using a modulation rate of 4, an alpha value of 0.25, and a base rate of 200 KHz. This is demonstrated by the following application of Equation 1, in which MR=4, BR=200 KHz and α=0.25:
CS=4*200KHz*(1+0.25)=1000KHz or 1MHz
Thus, an embodiment of the present invention that supports variable base rates will provided far more flexibility to efficiently fill usable spectrum.

3. Alpha Value Reduction in Accordance with an Embodiment of the Present Invention

A further embodiment of the present invention allows for more efficient spectrum utilization as compared to conventional DOCSIS communication systems by allowing the value of alpha to be reduced. Unlike prior embodiments described herein, this approach does not improve efficiency by leveraging statistical multiplexing. Rather, reducing alpha simply reduces the amount of excess spectrum, or overhead, associated with Nyquist filtering.

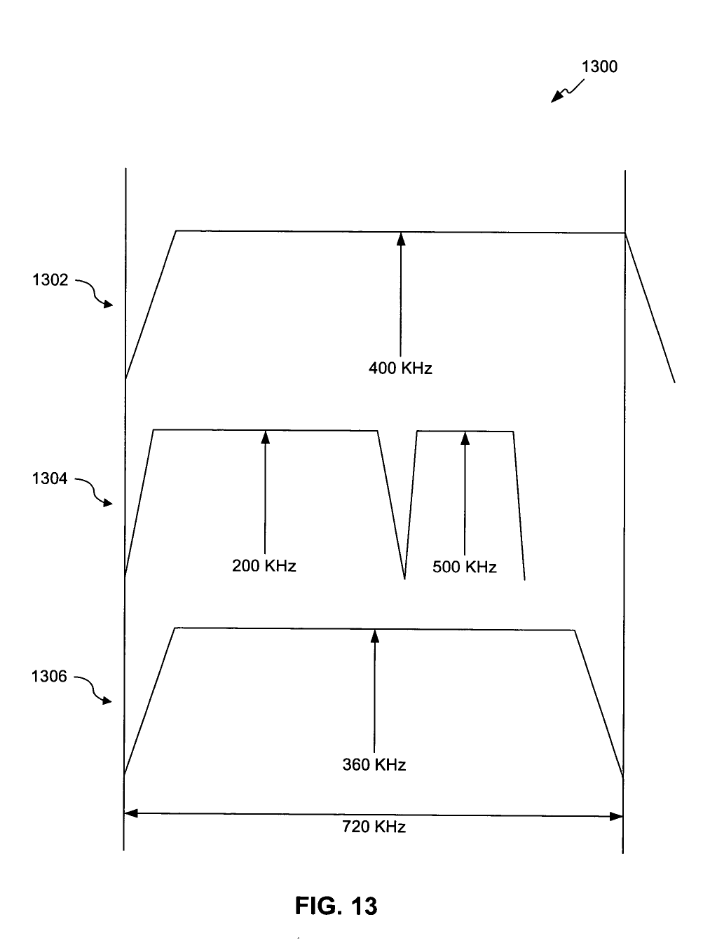

FIG. 13 further illustrates this concept by depicting three different approaches for utilizing a 720 MHz spectrum band. A first approach 1302 illustrates that a conventional DOCSIS communication system cannot utilize a single channel having a modulation rate of 4. This is because the tail of the channel would exceed the 720 KHz available. To properly utilize this spectrum band, a conventional DOCSIS communication system would have to create two channels. For example, approach 1304 illustrates how this could be accomplished by a conventional DOCSIS communication system. Approach 1304 utilizes a first 400 KHz channel (MR=2) centered at 200 KHz into the 720 MHz band and a second 200 KHz channel (MR=1) centered at 500 KHz into the 720 MHz band. This approach can only utilize 600 KHz of the 720 KHz available.

By permitting alpha to be reduced from 0.25 to 0.125, an embodiment of the present invention permits a single channel having a modulation rate of 4 to be fit into the 720 KHz band. This is illustrated by approach 1306 depicted in FIG. 13. This is also demonstrated by the following application of Equation 1, in which MR=4, BR 160 KHz and α=0.125:
CS=4*160KHz*(1+0.125)=720KHz
This approach provides a symbol rate of 640 Ksym/s (kilosymbols/second). In contrast, the best symbol rate that can be provided by approach 1304 is 480 Ksym/s. Consequently, the reduction of alpha in this case provides a system that is 33% more efficient.

4. Combination of One or More Proprietary Communication Parameters in Accordance with an Embodiment of the Present Invention

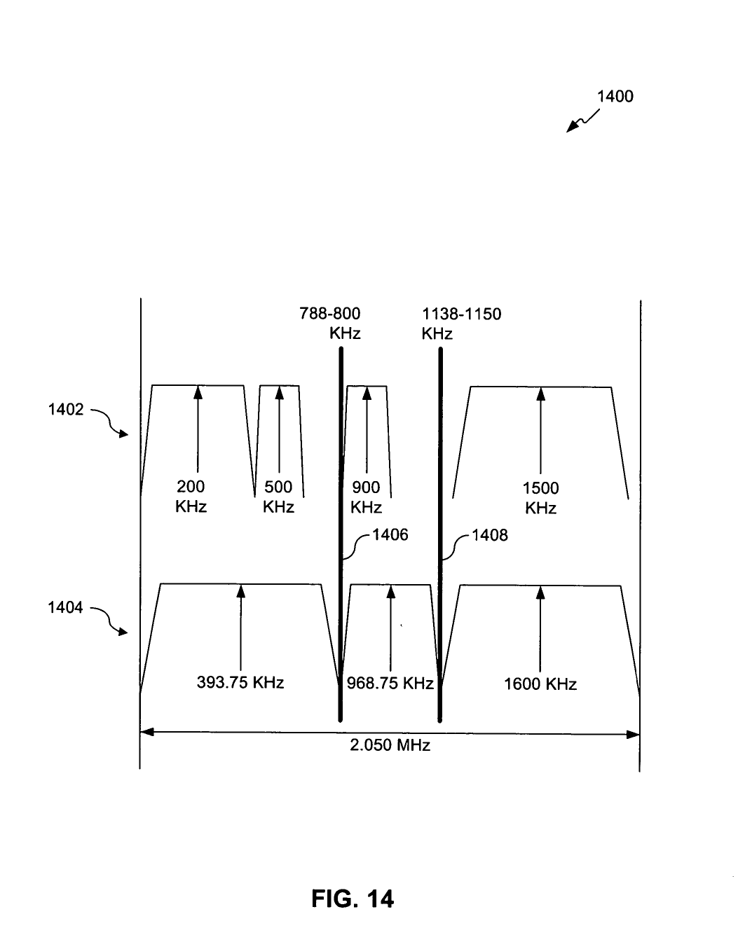

In accordance with an embodiment of the present invention, two or more of the techniques of allowing more modulation rates than permitted by DOCSIS, using a variable base rate, or reducing alpha are combined to achieve more efficient bandwidth utilization. FIG. 14 illustrates two different approaches 1402 and 1404 for utilizing a noisy 2.05 MHz band of spectrum. In FIG. 14, gray bands 1406 and 1408 represent noise. The noise exists in two bands within the spectrum: a first band at 788 to 800 KHz into the spectrum, and a second band at 1138 to 1150 KHz into the spectrum. For the purpose of this example, it will be assumed that these regions are so noisy that they cannot be used.

Approach 1402 represents the optimal bandwidth utilization that can be achieved by a conventional DOCSIS communication system. Approach 1402 places two channels in the first 788 KHz spectrum band: a first 400 KHz channel centered at 200 KHz into the 2.05 MHz band and a second 200 KHz channel centered at 500 KHz into the 2.05 MHz band. Also, due to the limitations of DOCSIS, approach 1402 can only fit a 200 KHz channel in the 338 KHz band of spectrum between noise bands 1406 and 1408. Finally, approach 1402 can only fit an 800 KHz channel in the 900 KHz band that exists between 1150 KHz and 2.05 MHz.

The symbol rate for the 400 KHz channel centered at 200 KHz may be determined through application of Equation 2, with MR=2 and BR=160 KHz:
SR=2*160KHz=320Ksym/s.
Likewise, the symbol rate of the channels centered at 500 KHz, 900 KHz and 1500 KHz into the 2.05 MHz spectrum band can be calculated using Equation 2. The resulting symbol rates for these channels are 160 Ksym/s, 160 Ksym/s, and 640 Ksym/s, respectively. The total symbol rate for approach 1402 is the sum of the symbol rates of the individual channels. Consequently, the total symbol rate for approach 1402 is:
SR=320Ksym/s+160Ksym/s+160Ksym/s+640Ksym/s=1280Ksym/s

Approach 1404 represents a solution that may be achieved in accordance with an embodiment of the present invention that supports a lower base rate, a lower alpha value and more modulation rates than normally permitted by a DOCSIS communication system. In accordance with this example, a base rate of 100 KHz and an alpha value of 0.125 are permitted, while modulation rates are permitted to be integers as opposed to a power of two.

Based on these proprietary parameters, approach 1404 includes the creation of a first channel centered at 393.75 KHz into the 2.05 MHz band with MR=7, BR=100 KHz, and α=0.125. This first channel completely fills the first 788 KHz of the 2.05 MHz band. Approach 1404 also includes the creation of a second channel centered at 968.75 KHz into the 2.05 MHz band with MR=3, BR=100 KHz, and α=0.125. The second channel fills the 338 KHz band between noise bands 1406 and 1408. Finally, approach 1404 includes the creation of a third channel centered at 1600 KHz into the 2.05 MHz band with MR=8, BR=100 KHz, and α=0.125. The third channel fills the remaining 900 KHz of the 2.05 MHz spectrum band.

The symbol rates for the three channels in approach 1404 are 700 Ksym/s, 300 Ksym/s, and 800 Ksym/s, respectively, resulting in an overall symbol rate of 1800 Ksym/s for approach 1404, as compared to the overall symbol rate of 1280 Ksym/s for conventional approach 1402. Approach 1404 leverages all three techniques of allowing more modulation rates than permitted by DOCSIS, using a variable base rate, and reducing alpha to provide improved overall channel efficiency. This approach will also provide further efficiency if statistical multiplexing is applied to the three large channels as opposed to the four small channels created by a conventional DOCSIS communication system.

5. Communication Over a Logical Channel that Supports Proprietary Communication Parameters Related to Bandwidth Utilization in Accordance with an Embodiment of the Present Invention

The manner in which a CMTS establishes a logical channel that supports proprietary features (such as support for proprietary communication parameters related to bandwidth utilization), receives registration information from a cable modem indicating support for the proprietary features, and assigns the cable modem to the logical channel based on the receipt of registration information is described in detail elsewhere herein.

Once a cable modem that supports proprietary communication parameters has been moved to the appropriate logical channel, communication between the CMTS and the cable modem must occur to enable the proprietary features. There are many different ways to communicate to enable the proprietary features. One option is to leverage existing communications and MAC protocols. Another option is to leverage an existing communications protocol and utilize a new MAC protocol. A further option would be to utilize both a new communications protocol and MAC protocol.

The most obvious choice for selecting between the many existing communications and MAC protocols would be to leverage the DOCSIS protocol. This protocol is used to range and register the cable modems prior to determining if the modems have proprietary features. In accordance with an embodiment of the present invention, the logical channel that supports proprietary features uses an extended version of the DOCSIS protocol to support one or more of three parameters that are different from DOCSIS: modulation rate, base rate, and alpha.

DOCSIS already provides a field in the UCD message to transmit the modulation rate for a channel from the CMTS to the cable modem. In an embodiment, this field is redefined to support the proprietary rates. In accordance with DOCSIS, a base rate and alpha value are not transmitted to the cable modems; rather, these values are implied by the DOCSIS system. Accordingly, an embodiment of the present invention utilizes new TLV fields in the UCD message to transmit a base rate and alpha value. Once these TLV fields are defined, a base rate and alpha value can be sent by the CMTS to the cable modem as part of a UCD message. Note that another approach for reducing alpha would be to send the Nyquist filter taps, rather than the alpha value, to the cable modem. This could also be achieved through the addition of a new TLV field to the UCD message.

Thus, all the required information can be communicated to the cable modems with a new UCD message. There are at least two ways of presenting this new UCD message to the cable modems. In accordance with a first embodiment of the invention, an existing Type 2 or Type 29 UCD message with reserved TLV fields is used. In such an embodiment, the UCD messages are sent only to the modems in the logical channel that supports the proprietary features. This can be accomplished, for example, using unicast or multicast UCD messages. In accordance with a second embodiment of the invention, a reserved message type (Type>31) is used for the new UCD message. This message can be sent to all cable modems because this message will be ignored by conventional DOCSIS cable modems that do not use message type 31.

Leveraging DOCSIS in the above-described manner does bring some risk. For example, the DOCSIS protocol could expand over time. If the expansion consumes the reserved fields in the UCD message that are required to support the proprietary features, then these features cannot be used. One solution to this problem entails dynamic allocation of the reserved fields in the cable modems. This permits the system to move the fields to a safe location.

In an alternate embodiment, the information to enable proprietary features, such as proprietary communication parameters related to bandwidth utilization, are sent by the CMTS to the cable modems over an IP link. For example, the IP link may comprise a TCP connection or a UDP transfer, which are both protocols are commonly used with cable modems. In an embodiment, a new UCD message with the proprietary features is transported over the IP links to the cable modems of interest. Even if DOCSIS expanded to cover all the reserved fields, this approach would still work.

In an alternate embodiment, an additional MAC protocol is defined that includes new messages used by cable modems that support proprietary features. The new messages are used to send the proprietary information to the cable modems. For example, one or more of a modulation rate message, a base rate message, an alpha message, and/or a Nyquist filter taps message could be defined for transmitting the respective proprietary values over an IP link.

Finally, in a further embodiment, a new messaging and communications protocol set is derived to support these channel efficiency features in a proprietary logical channel. There are numerous options for a solution deriving protocols to send proprietary information.

F. Processor-Based Implementations

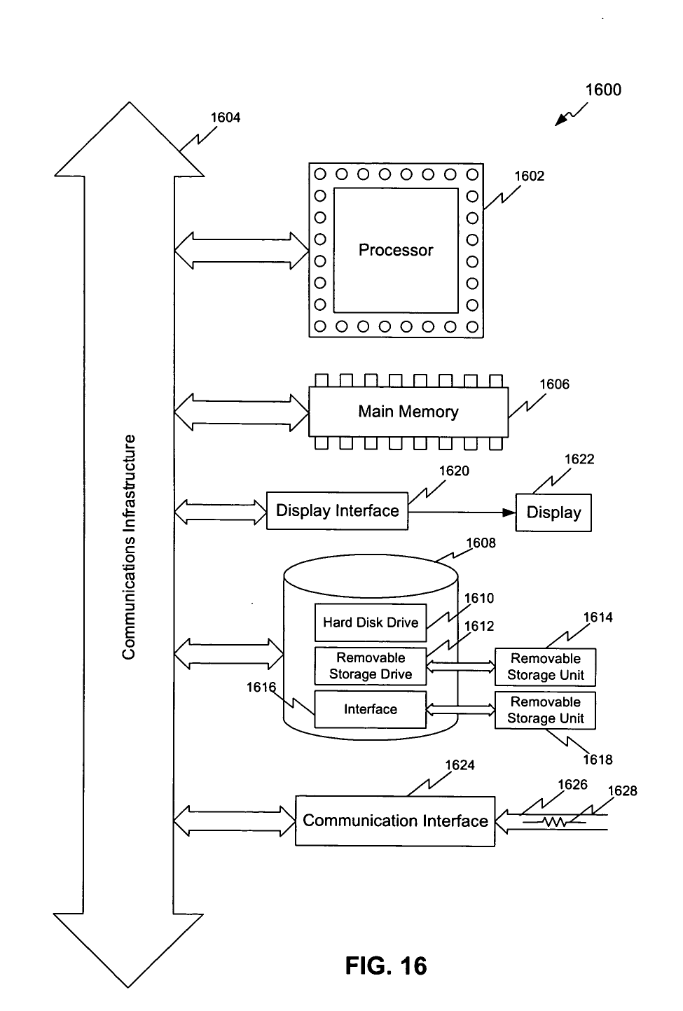

As discussed elsewhere herein, various features of the present invention may be implemented in software and executed by a processor. FIG. 16 depicts an example processor-based system 1600 that may execute software for implementing the features of the present invention, including, but not limited to, any of the features of CMTS 202 or cable modems 206a-206n described above in reference to FIG. 2, and any of the method steps of flowcharts 300, 400, 700, 800, 900, and 1000, and 1500 described above in reference to FIGS. 3, 4, 7, 8, 9, 10, and 15, respectively.

As shown in FIG. 16, example system 1600 includes a processor 1602 for executing software routines in accordance with embodiments of the present invention. Although a single processor is shown for the sake of clarity, system 1600 may also comprise a multi-processor system. Processor 1602 is connected to a communications infrastructure 1604 for communication with other components of system 1600. Communications infrastructure 1604 may comprise, for example, a communications bus, cross-bar, or network.

System 1600 further includes a main memory 1606, such as a random access memory (RAM), and a secondary memory 1608. Secondary memory 1608 may include, for example, a hard disk drive 1610 and/or a removable storage drive 1612, which may comprise a floppy disk drive, a magnetic tape drive, an optical disk drive, flash memory, or the like. Removable storage drive 1612 reads from and/or writes to a removable storage unit 1614 in a well known manner. Removable storage unit 1614 may comprise a floppy disk, magnetic tape, optical disk, or the like, which is read by and written to by removable storage drive 1612. As will be appreciated by persons skilled in the relevant art(s), removable storage unit 1614 includes a computer usable storage medium having stored therein computer software and/or data.

In alternative embodiments, secondary memory 1608 may include other similar means for allowing computer programs or other instructions to be loaded into system 1600. Such means can include, for example, a removable storage unit 1618 and an interface 1616. Examples of a removable storage unit 1618 and interface 1616 include a program cartridge and cartridge interface (such as that found in video game console devices), a removable memory chip (such as an EPROM, or PROM) and associated socket, and other removable storage units 1618 and interfaces 1616 that allow software and data to be transferred from removable storage unit 1618 to system 1600.

System 1600 further includes a display interface 1620 that forwards graphics, text, and other data from communications infrastructure 1604 or from a frame buffer (not shown) for display to a user on a display unit 1622.

System 1600 also includes a communication interface 1624. Communication interface 1624 allows software and data to be transferred between system 1600 and external devices via a communication path 1626. Examples of communication interface 1624 include a modem, a network interface (such as Ethernet card or 802.11b interface), a communication port, and the like. Software and data transferred via communication interface 1624 are in the form of signals 1628 which can be electronic, electromagnetic, optical or other signals capable of being received by communication interface 1624. These signals 1628 are provided to communication interface 1624 via communication path 1626.

As used herein, the term “computer program product” may refer, in part, to removable storage unit 1614, removable storage unit 1618, a hard disk installed in hard disk drive 1610, or a carrier wave carrying software over communication path 1626 (wireless link or cable) to communication interface 1624. A computer useable medium can include magnetic media, optical media, or other recordable media, or media that transmits a carrier wave or other signal. These computer program products are means for providing software to system 1600.

Computer programs (also called computer control logic) are stored in main memory 1606 and/or secondary memory 1608. Computer programs can also be received via communication interface 1624. Such computer programs, when executed, enable system 1600 to perform the features of the present invention as discussed herein. In particular, the computer programs, when executed, enable processor 1602 to perform the features of the present invention. Accordingly, such computer programs represent controllers of the system 1600.

The features of the present invention can be implemented as control logic in software, firmware, hardware or any combination thereof. In an embodiment where features of the present invention are implemented using software, the software may be stored in a computer program product and loaded into system 1600 using removable storage drive 1612, hard disk drive 1610 or communication interface 1624. Alternatively, the computer program product may be downloaded to system 1600 over communication path 1626. The software, when executed by processor 1602, causes processor 1602 to perform features of the invention as described herein.

In another embodiment, features of the present invention are implemented in firmware and/or hardware using, for example, hardware components such as application specific integrated circuits (ASICs). Implementation of a hardware state machine so as to perform the functions described herein will be apparent to persons skilled in the relevant art(s) from the teachings herein.

G. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. For example, the present invention is not limited to cable modem systems and equipment as described herein, but is equally applicable to any DOCSIS-compliant broadband communications system, including but not limited to broadband terrestrial fixed wireless systems, two-way satellite communication systems, and DSL (Digital Subscriber Line) networks. Accordingly, the breadth and scope of the present invention should not be limited by any of the above-described exemplary embodiments, but should be defined only in accordance with the following claims and their equivalents.

1. A method for improving channel efficiency in a broadband communication system that complies with a Data Over Cable Service Interface Specification (DOCSIS) standard, comprising:
establishing a logical channel for communication between a first device that supports at least one proprietary communication parameter associated with bandwidth utilization and other devices that support said at least one proprietary communication parameter;
receiving registration information from a second device, wherein said registration information indicates that said second device supports said at least one proprietary communication parameter; and
assigning said second device to said logical channel in response to receiving said registration information.

2. The method of claim 1, wherein said first device comprises a cable modem termination system (CMTS) and said second device comprises a cable modem.

3. The method of claim 1, wherein said at least one proprietary communication parameter comprises a modulation rate.

4. The method of claim 1, wherein said at least one proprietary communication parameter comprises a base rate.

5. The method of claim 1, wherein said at least one proprietary communication parameter comprises an alpha value.

6. The method of claim 1, wherein said establishing a logical channel comprises generating an Upstream Channel Descriptor (UCD) message, wherein said UCD message includes said at least one proprietary communication parameter.

7. The method of claim 6, wherein said generating a UCD message comprises generating a UCD message having a version field or a type field that comprises a value not provided for by the DOCSIS standard.

8. The method of claim 6, wherein said establishing a logical channel further comprises sending said UCD message only to devices that support said at least one proprietary communication parameter.

9. The method of claim 8, wherein said sending said UCD message only to devices that support said at least one proprietary communication parameter comprises:
accessing a database of identifiers of devices that support said at least one proprietary communication parameter; and
generating a unicast UCD message addressed to each of said devices having an identifier in said database.

10. The method of claim 8, wherein said sending said UCD message only to devices that support said at least one proprietary communication parameter comprises:
accessing an identifier that identifies a plurality of devices that support said at least one proprietary communication parameter; and
generating a multicast UCD message addressed to said plurality devices identified by said identifier.

11. The method of claim 1, wherein said receiving said registration information from a second device comprises:
sending a first unicast message to said second device to determine if said second device implements any proprietary features;
receiving a message from said second device, wherein said message indicates support by said second device for said at least one proprietary communication parameter; and
sending a second unicast message to said second device, wherein said second unicast message indicates support by said first device for said at least one proprietary communication parameter.

12. The method of claim 1, wherein said assigning said second device to said logical channel comprises generating a unicast message to said second device identifying said logical channel.

13. A cable modem termination system (CMTS) for improving channel efficiency in a cable modem system that complies with a Data Over Cable Service Interface Specification (DOCSIS) standard, comprising:
an upstream channel manager adapted to establish a logical channel for communication with cable modems that support at least one proprietary communication parameter associated with bandwidth utilization; and
a registration module adapted to receive registration information from a cable modem, wherein said registration information indicates that said cable modem supports said at least one proprietary communication parameter, and to assign said cable modem to said logical channel in response to receiving said registration information.

14. The CMTS of claim 13, wherein said at least one proprietary communication parameter comprises a modulation rate.

15. The CMTS of claim 13, wherein said at least one proprietary communication parameter comprises a base rate.

16. The CMTS of claim 13, wherein said at least one proprietary communication parameter comprises an alpha value.

17. The CMTS of claim 13, wherein said upstream channel manager is adapted to determine whether or not to establish said logical channel.

18. The CMTS of claim 13, wherein said upstream channel manager is adapted to generate a UCD message that includes said at least one proprietary communication parameter.

19. The CMTS of claim 18, wherein said upstream channel manager is adapted to generate a UCD message having a version field or a type field that comprises a value not provided for by the DOCSIS standard.

20. The CMTS of claim 18, wherein said upstream channel manager is further adapted to send said UCD message only to cable modems that support said at least one proprietary communication parameter.

21. The CMTS of claim 20, wherein said upstream channel manager is adapted to access a database of identifiers of cable modems that support said at least one proprietary communication parameter, and to generate a unicast UCD message addressed to each of said cable modems having an identifier in said database.

22. The CMTS of claim 20, wherein said upstream channel manager is adapted to access an identifier that identifies a plurality of cable modems that support said at least one proprietary communication parameter, and to generate a multicast UCD message addressed to said plurality devices identified by said identifier.

23. The CMTS of claim 13, wherein said registration module is adapted to send a first unicast message to said cable modem to determine if said cable modem implements any proprietary features, to receive a message from said cable modem, wherein said message indicates that said cable modem supports said at least one proprietary communication parameter, and to send a second unicast message to said cable modem, wherein said second unicast message indicates that said CMTS supports said at least one proprietary communication parameter.

24. The CMTS of claim 13, wherein said registration module is adapted to generate a unicast message to said cable modem identifying said logical channel.

25. A computer program product comprising a computer useable medium having computer program logic recorded thereon for enabling a processor to facilitate communication between devices in a broadband communication system that complies with a Data Over Cable Service Interface Specification (DOCSIS) standard, said computer program logic comprising:
means for enabling the processor to establish a logical channel for communication between a first device that implements at least one proprietary communication parameter associated with bandwidth utilization and other devices that support said at least one proprietary communication parameter;
means for enabling the processor to receive registration information from a second device, wherein said registration information indicates that said second device supports said at least one proprietary communication parameter; and
means for enabling the processor to assign said second device to said logical channel in response to receiving said registration information.

26. The computer program product of claim 25, wherein said first device comprises a cable modem termination system (CMTS) and said second device comprises a cable modem.

27. The computer program product of claim 25, wherein said at least one proprietary communication parameter comprises a modulation rate.

28. The computer program product of claim 25, wherein said at least one proprietary communication parameter comprises a base rate.

29. The computer program product of claim 25, wherein said at least one proprietary communication parameter comprises an alpha value.

30. The computer program product of claim 25, wherein said means for enabling the processor to establish a logical channel comprises means for enabling the processor to generate an Upstream Channel Descriptor (UCD) message, wherein said UCD message includes said at least one proprietary communication parameter.

31. The computer program product of claim 30, wherein said means for enabling the processor to generate a UCD message comprises means for enabling the processor to generate a UCD message having a version field or a type field that comprises a value not provided for by the DOCSIS standard.

32. The computer program product of claim 30, wherein said means for enabling the processor to establish a logical channel further comprises means for enabling the processor to send said UCD message only to devices that support said at least one proprietary communication parameter.

33. The computer program product of claim 32, wherein said means for enabling the processor to send said UCD message only to devices that support said at least one proprietary communication protocol comprises:
means for enabling the processor to access a database of identifiers of devices that support said at least one proprietary communication protocol; and
means for enabling the processor to generate a unicast UCD message addressed to each of said devices having an identifier in said database.

34. The computer program product of claim 32, wherein said means for enabling the processor to send said UCD message only to devices that support said at least one proprietary communication parameter comprises:
means for enabling the processor to access an identifier that identifies a plurality of devices that support said at least one proprietary communication parameter;
means for enabling the processor to generate a multicast UCD message addressed to said plurality devices identified by said identifier.

35. The computer program product of claim 25, wherein said means for enabling the processor to receive said registration information from a second device comprises:
means for enabling the processor to send a first unicast message to said second device to determine if said second device implements any proprietary features;
means for enabling the processor to receive a message from said second device, wherein said message indicates support by said second device for said at least one proprietary communication parameter; and
means for enabling the processor to send a second unicast message to said second device, wherein said second unicast message indicates support by said first device for said at least one proprietary communication parameter.

36. The computer program product of claim 25, wherein said means for enabling the processor to assign said second device to said logical channel comprises means for enabling the processor to generate a unicast message to said second device identifying said logical channel.
